(19) United States
(12) Patent Application Publication
(10) Pub. No.: US 2025/0298205 A1
(43) Pub. Date: Sep. 25, 2025

(54) OPTICAL WAVEGUIDE AND OPTICAL CONCENTRATION MEASURING INSTRUMENT

(71) Applicant: Asahi Kasei Microdevices Corporation, Tokyo (JP)

(72) Inventors: Tatsushi YAGI, Tokyo (JP); Koshi KURASHIMA, Tokyo (JP)

(21) Appl. No.: 19/080,933

(22) Filed: Mar. 17, 2025

(30) Foreign Application Priority Data
Mar. 25, 2024 (JP) 2024-048807

(51) Int. Cl. G02B 6/42; G01N 21/01; G01N 21/59; G02B 6/293

(52) U.S. Cl. CPC G02B 6/4298; G01N 21/01; G02B 6/29338; G02B 6/4215; G01N 21/59

(57) ABSTRACT

There is provided an optical waveguide including: light introduction portion; a light extraction portion; a light circulation portion of an elliptical shape; a first waveguide which is connected to the light introduction portion at a starting end of the first waveguide in a propagation direction of light, and which is connected to the light circulation portion at a terminal end of the first waveguide; a second waveguide which is connected to the light circulation portion at a starting end of the second waveguide in a propagation direction of light, and which is connected to the light extraction portion at a terminal end of the second waveguide; and a support layer which supports the light circulation portion, in which a center of gravity of the light circulation portion is arranged at a position deviated from an extension direction of the first waveguide and the second waveguide, in a top plan view.

The contents of the following Japanese patent application(s) are incorporated herein by reference:
No. 2024-048807 filed in JP on Mar. 25, 2024

### BACKGROUND

### 1. Technical Field

The present invention relates to an optical waveguide and an optical concentration measuring instrument.

### 2. Related Art

Patent Document 1 discloses a “solid state microcavity optical device including a solid state microcavity light emitter”.

### PRIOR ART DOCUMENTS

### Patent Document

Patent Document 1: Specification of U.S. Patent Application Publication No. 2008/0089367

### SUMMARY

In a first aspect of the present invention, there is provided an optical waveguide including: a light circulation portion of an elliptical shape; a first waveguide which is connected to the light circulation portion at a terminal end of the first waveguide in a propagation direction of light; a second waveguide which is connected to the light circulation portion at a starting end of the second waveguide in a propagation direction of light, at a position different from a position at which the light circulation portion is connected to the first waveguide; a support layer which supports the light circulation portion; and a substrate which supports the support layer, in which, in a top plan view, a center of gravity of the light circulation portion is arranged at a position deviated from an extension direction of the first waveguide and the second waveguide, and light introduced from the light introduction portion propagates through the first waveguide, the light circulation portion, and the second waveguide, in order.

Note that the summary clause does not necessarily describe all necessary features of the embodiments of the present invention. The present invention may also be a sub-combination of the features described above.

### BRIEF DESCRIPTION OF THE DRAWINGS

FIG. 1 is a top plan view showing a schematic configuration of an optical waveguide 100 according to a first embodiment.

FIG. 2 is a side view showing a schematic configuration of the optical waveguide 100 according to the first embodiment.

FIG. 3 is a side view showing a schematic configuration of the optical waveguide 100 according to the first embodiment.

FIG. 4 is a top plan view showing a schematic configuration of an optical waveguide 110 according to a second embodiment.

FIG. 5 is a top plan view showing a schematic configuration of an optical waveguide 120 according to a third embodiment.

FIG. 6 is a top plan view showing a schematic configuration of an optical waveguide 130 according to a fourth embodiment.

FIG. 7 is a top plan view showing a schematic configuration of an optical waveguide 140 according to a fifth embodiment.

FIG. 8 is a top plan view showing a schematic configuration of an optical waveguide 150 according to a sixth embodiment.

FIG. 9 is a side view for describing a method of manufacturing the optical waveguide 100 according to the first embodiment.

FIG. 10 is a side view showing a schematic configuration of an optical waveguide 160 according to a seventh embodiment.

FIG. 11 is a top plan view showing a schematic configuration of an optical waveguide 170 according to an eighth embodiment.

### DESCRIPTION OF EXEMPLARY EMBODIMENTS

The present invention will be described below through embodiments of the invention, but the following embodiments do not limit the invention according to the claims. In addition, not all of the combinations of features described in the embodiments are essential to the solution of the invention.

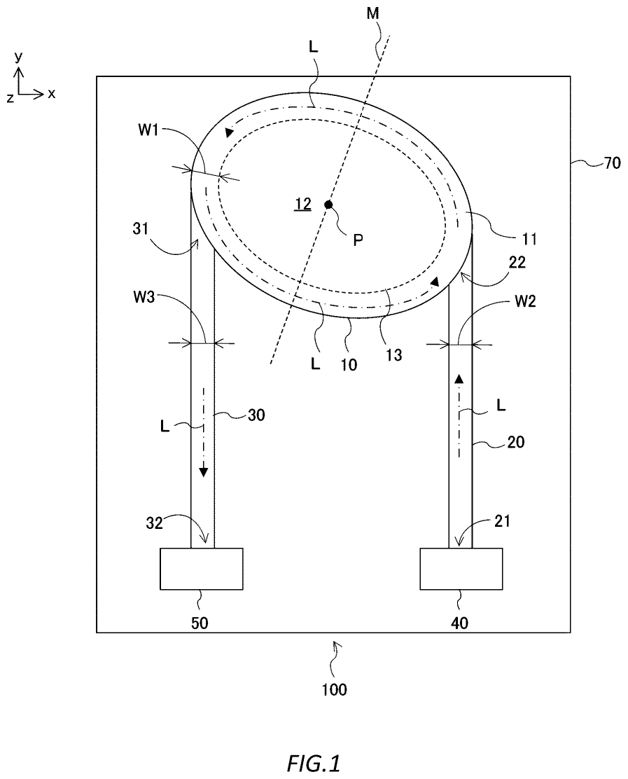

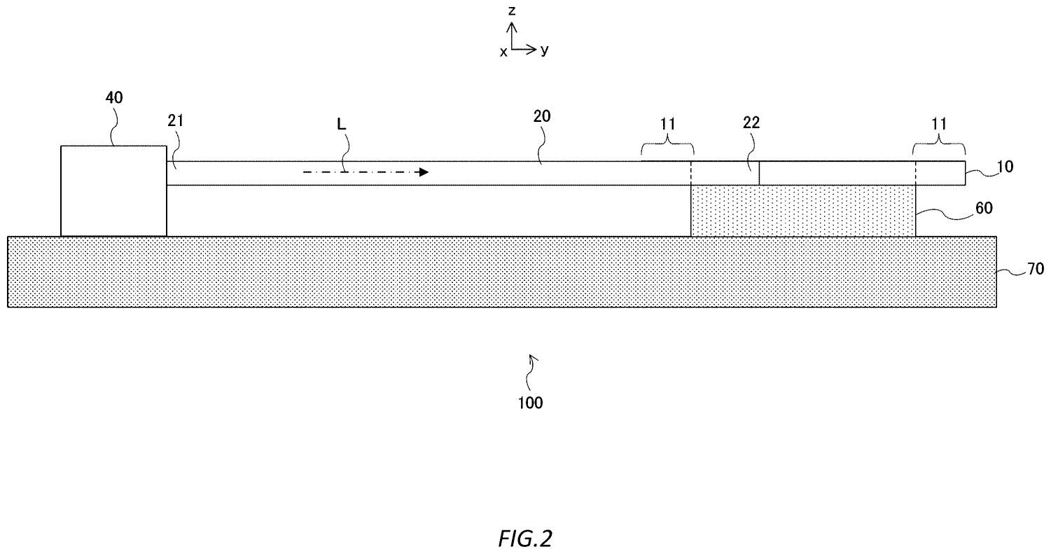

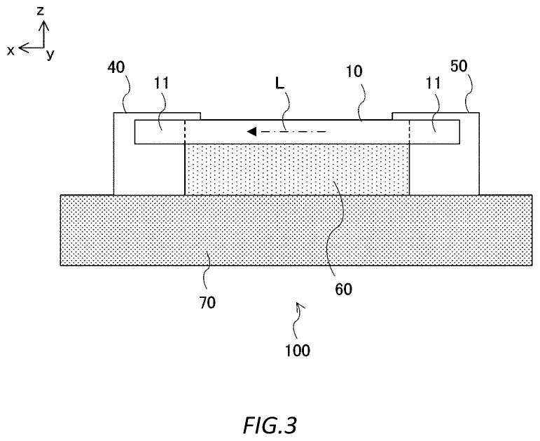

FIG. 1 is a top plan view showing a schematic configuration of an optical waveguide 100 according to a first embodiment. FIG. 2 and FIG. 3 are side views showing a schematic configuration of the optical waveguide 100 according to the first embodiment. FIG. 2 shows a view seen from a +x direction side in FIG. 1, and FIG. 3 shows a view seen from a +y direction side in FIG. 1.

The optical waveguide 100 in the first embodiment has a light circulation portion 10 of an elliptical shape, a first waveguide 20, a second waveguide 30, an LED (Light Emitting Diode) 40 as a light introduction portion, and a PD (photodiode) 50 as a light extraction portion.

In a side view, the light circulation portion 10 is supported by a cladding layer 60, and the cladding layer 60 is supported by a substrate 70. Additionally speaking, the cladding layer 60 is an example of a support layer that supports the light circulation portion 10.

A dashed and dotted arrow in FIG. 1 indicates a propagation direction of light L. The light L emitted from the LED 40 propagates through the first waveguide 20, the light circulation portion 10, the second waveguide 30, and the PD 50, in order. The figure shows an xyz coordinate system. The optical waveguide 100 is used in an optical concentration measuring instrument such as a gas sensor that detects a concentration of a detection target gas based on transmittance of light or the like.

The light circulation portion 10 has an elliptical shape. The light circulation portion 10 has an outer peripheral floating portion 11 outside a dotted line 13 and a center portion 12 inside the dotted line 13. When the light is introduced into an optical waveguide member of an elliptical shape from a peripheral edge thereof, a phenomenon in which the light locally exists at a circumferential portion, occurs. That is, the outer peripheral floating portion 11 is an outer peripheral portion of the light circulation portion 10, and is a portion in which most of the light L incident from the first waveguide 20 circulates and propagates. It should be noted that the outer peripheral floating portion 11 and the center portion 12 are constituted by the same material. A length of the outer peripheral floating portion 11 in a radial direction is W1. It is desirable that a minor radius of the light circulation portion 10 is twice or more of the length W1 of the outer peripheral floating portion 11 in the radial direction. A ratio of a major radius to the minor radius, that is, the major axis: the minor axis, is preferably 1:1 to 4:1. As shown in FIG. 1, a center of gravity P of the light circulation portion 10 is arranged at a position deviated from an extension direction of the first waveguide 20 and the second waveguide 30, in a top plan view.

The first waveguide 20 is an optical waveguide of a linear shape. The first waveguide 20 has a starting end 21 and a terminal end 22 in the propagation direction of the light L. The light L propagates from the starting end 21 toward the terminal end 22. The first waveguide 20 is connected, at the starting end 21, to the LED 40 which is a light introduction portion; and is connected, at the terminal end 22, to the outer peripheral floating portion 11 of the light circulation portion 10. It is desirable that the first waveguide 20 is connected to the light circulation portion 10 at an angle along a tangent of an ellipse of the light circulation portion 10. That is, the tangent of an ellipse of an outer edge of the light circulation portion 10 overlaps an outer edge of the waveguide 20. This makes it possible for the light L to efficiently propagate from the first waveguide 20 to the light circulation portion 10, and it is possible to suppress a propagation loss of the light L. Additionally speaking, the first waveguide 20 terminates at the terminal end 22, and does not penetrate through to an opposite side of the light circulation portion 10 from the first waveguide 20.

The second waveguide 30 is an optical waveguide of a linear shape. The second waveguide 30 has a starting end 31 and a terminal end 32 in the propagation direction of the light L. The light L propagates from the starting end 31 toward the terminal end 32. The second waveguide 30 is connected, at the starting end 31, to the outer peripheral floating portion 11 of the light circulation portion 10; and is connected, at the terminal end 32, to the photodiode (PD) 50 which is a light extraction portion. The second waveguide 30 is connected to the light circulation portion 10 at a position different from a position at which the light circulation portion 10 is connected to the first waveguide 20. It is desirable that the second waveguide 30 is connected to the light circulation portion 10 at an angle along the tangent of an ellipse of the light circulation portion 10. This makes it possible for the light L to efficiently propagate from the light circulation portion 10 to the second waveguide 30, and it is possible to suppress a propagation loss of the light L. Additionally speaking, the second waveguide 30 is started from the starting end 31, and does not penetrate from an opposite side of the light circulation portion 10 from the second waveguide 30.

It is desirable that a width W2 of the first waveguide 20 and a width W3 of the second waveguide 30 are shorter than the length W1 of the outer peripheral floating portion 11 in the radial direction. This makes it possible for the cladding layer 60 to be positioned away from a connection portion between the light circulation portion 10 and the first waveguide 20, and thus an optical coupling efficiency is enhanced and a propagation loss of the light L is reduced. In addition, it is desirable for the length W1 of the outer peripheral floating portion 11 in the radial direction to be twice or less of the width W2 of the first waveguide 20 and the width W3 of the second waveguide 30. This prevents the outer peripheral floating portion 11 from bending.

As shown in FIG. 1, the light L propagated from the first waveguide 20 to the light circulation portion 10 circulates in the outer peripheral floating portion 11 of the light circulation portion 10. A part of the light L circulating in the outer peripheral floating portion 11 of the light circulation portion 10 is incident on the second waveguide 30 from a connection portion between the light circulation portion 10 and the second waveguide 30. Another part of the light L circulating in the outer peripheral floating portion 11 of the light circulation portion 10 circulates again in the light circulation portion 10 without being incident on the second waveguide 30. In this way, the light L is incident on the second waveguide 30 little by little while circulating multiple times in the outer peripheral floating portion 11 of the light circulation portion 10.

FIG. 1 shows a minor axis M of the light circulation portion 10 which has an elliptical shape. The minor axis M of the light circulation portion 10 is tilted from the extension direction (in a y direction) of the first waveguide 20 and the second waveguide 30. This makes it possible for a connection angle between the first waveguide 20 and the light circulation portion 10 to be gentle, and makes it possible for the light L to efficiently propagate from the first waveguide 20 to the light circulation portion 10, and it is possible to suppress a propagation loss of the light L. Similarly, this makes it possible for a connection angle between the second waveguide 30 and the light circulation portion 10 to be gentle, and makes it possible for the light L to efficiently propagate from the light circulation portion 10 to the second waveguide 30, and it is possible to suppress a propagation loss of the light L.

The first waveguide 20, the second waveguide 30, and the light circulation portion 10 are constituted by materials through which the light L of a wavelength to be used is able to propagate. A specific example includes gallium arsenide (GaAs), silicon (Si), germanium (Ge), or the like. Each of the first waveguide 20, the second waveguide 30, and the light circulation portion 10 may be formed of a single material, or may be formed by stacking a plurality of materials. It is desirable that refractive indices at the wavelengths of the materials constituting the first waveguide 20, the second waveguide 30, and the light circulation portion 10 are higher than a refractive index at the wavelength of the material constituting the cladding layer 60.

When the material of the light circulation portion 10 is different from the materials of the first waveguide 20 and the second waveguide 30, it is desirable that the refractive index of the material constituting the light circulation portion 10 is higher than or equal to the refractive indices of the materials constituting the first waveguide 20 and the second waveguide 30. By increasing the refractive index of the material constituting the light circulation portion 10, it is possible to reduce the wavelength in the material in the light circulation portion 10, and it is possible to enhance the propagation efficiency of the light L, and to reduce a size of the ellipse of the light circulation portion 10.

In FIG. 2 and FIG. 3, the cladding layer 60 and the substrate 70 are indicated by hatching. The light circulation portion 10 having a great area is fixed to the substrate 70 via the cladding layer 60, thereby suppressing peeling off of the optical waveguide 100 from the substrate 70.

As shown in FIG. 2 and FIG. 3, the outer peripheral floating portion 11 of the light circulation portion 10 is not in contact with the cladding layer 60 and the substrate 70. In other words, the outer peripheral floating portion 11 is floating above the substrate 70, and serves as a flange, so to speak. The outer peripheral floating portion 11 of the light circulation portion 10 is not in contact with the cladding layer 60 and the substrate 70, thereby suppressing leaking of the light L circulating in the outer peripheral floating portion 11, from the cladding layer 60 or the substrate 70 to an outside, and it is possible to suppress a propagation loss of the light L. Additionally speaking, in the light circulation portion 10, a surface that is in contact with the cladding layer 60 and a portion above it correspond to the center portion 12, and a surface that is not in contact with the cladding layer 60 and a portion above it correspond to the outer peripheral floating portion 11.

As shown in FIG. 2 and FIG. 3, the first waveguide 20 and the second waveguide 30 are not in contact with the cladding layer 60 and the substrate 70. That is, the first waveguide 20 and the second waveguide 30 are floating waveguides in which portions other than portions that are connected to the light circulation portion 10, the LED 40, or the PD 50 are suspended in the air. In this manner, in comparison with a case where the first waveguide 20 and the second waveguide 30 are in contact with the cladding layer 60 or the substrate 70, it is possible to suppress leaking of the light L passing through the first waveguide 20 and the second waveguide 30, from the cladding layer 60 or the substrate 70 to an outside, and it is possible to suppress a propagation loss of the light L.

It is desirable that the first waveguide 20 and the second waveguide 30 which are floating waveguides have lengths of 200 μm or less. This suppresses bending of the floating portions of the first waveguide 20 and the second waveguide 30 and sticking to the substrate 70.

The cladding layer 60 is constituted by a material having a lower refractive index than those of the materials constituting the first waveguide 20, the second waveguide 30, and the light circulation portion 10. It is formed of aluminum gallium arsenide (AlGaAs), aluminum gallium oxide (AlGaO), aluminum gallium hydroxide (AlₓGa₁₋ₓ(OH)₃), or the like. When aluminum gallium arsenide (AlGaAs), aluminum gallium oxide (AlGaO), or aluminum gallium hydroxide (AlₓGa₁₋ₓ(OH)₃) is used as the material for the cladding layer 60, it is desirable that a ratio of the number of atoms of aluminum to the total number of atoms of aluminum and gallium is 90% or more. That is, it is preferable that a ratio of the number of atoms of aluminum to the number of atoms of gallium is 0.9:0.1 to 1.0:0. Alternatively, the cladding layer 60 may be formed of, for example, silicon dioxide (SiO₂).

According to the optical waveguide 100 in the first embodiment, the light L emitted from the LED 40 circulates multiple times in the outer peripheral floating portion 11 of the light circulation portion 10 before reaching the PD 50. This makes it possible to further increase an optical path length per unit area of the light L propagating from the LED 40 to the PD 50. Therefore, when the optical waveguide 100 is used as a sensor in an optical concentration measuring instrument or the like, it is possible to enhance sensitivity.

According to the optical waveguide 100 in the first embodiment, the optical waveguide 100 is fixed to the substrate 70 by the cladding layer 60 which supports the light circulation portion 10. In this manner, the light circulation portion 10 having a great area takes a role as a fixing anchor, and it is possible to suppress peeling off of the optical waveguide 100 from the substrate 70.

According to the optical waveguide 100 in the first embodiment, the light circulation portion 10 has an elliptical shape. This makes it possible to enhance resistance to a dimensional deviation in the light circulation portion 10, and to provide the optical waveguide 100 in which a propagation characteristic of the light L is not changed regardless of a manufacturing error of a certain degree.

In the first embodiment, the minor axis M of the light circulation portion 10 is tilted from the extension direction (in the y direction) of the first waveguide 20 and the second waveguide 30. However, the minor axis M of the light circulation portion 10 may not be tilted from the extension direction (in the y direction) of the first waveguide 20 and the second waveguide 30.

It should be noted that the light L hardly propagates through the center portion 12 of the light circulation portion 10, and thus a hole may be provided near the center portion 12. By changing a shape of the cladding layer 60 through the hole, it is possible to adjust the contact area between the light circulation portion 10 and the cladding layer 60. In this manner, it is possible to adjust holding power of the light circulation portion 10 and/or the stress applied to the interface between the light circulation portion 10 and the cladding layer 60 due to the internal stress difference. In addition, the elliptical shape of the light circulation portion 10 also includes a shape that is slightly different from a mathematical ellipse. For example, even in a shape having unevenness smaller than the wavelength of the light L or having a straight line provided in a part of an ellipse, as long as attenuation during the propagation of the light L is in a range allowed by the specification, it is possible to obtain an effect of the present embodiment. In addition, the support layer which supports the light circulation portion 10 may not be the optical cladding layer 60. For example, the support layer may be constituted by a material which is opaque to the light L that is used. It is possible to apply these modified examples to another embodiment.

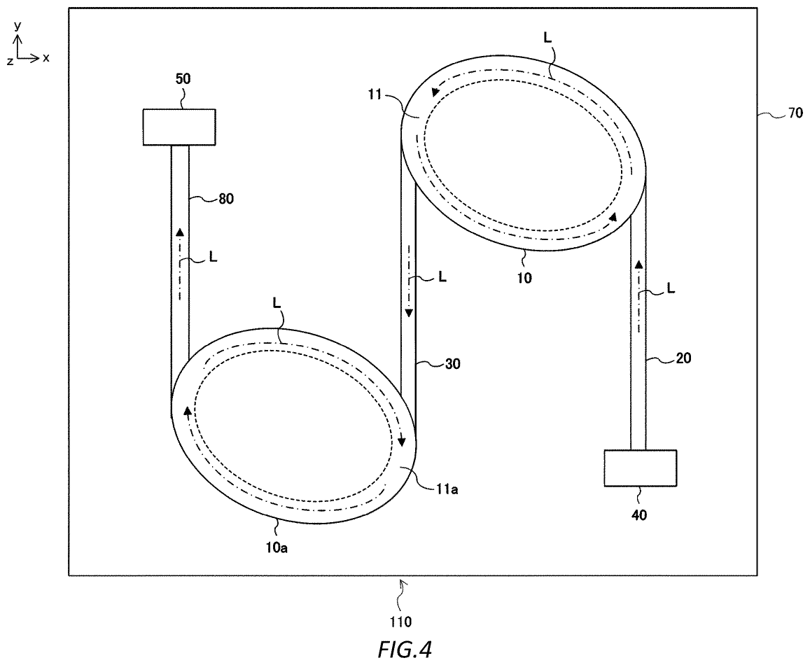

FIG. 4 is a top plan view showing a schematic configuration of an optical waveguide 110 according to a second embodiment. Hereinafter, a component that is the same as that of or in common with the optical waveguide 100 in the first embodiment will be denoted by the same sign and numeral and the description thereof will be omitted. In addition to the configuration of the optical waveguide 100 in the first embodiment, the optical waveguide 110 in the second embodiment has: a second light circulation portion 10a of an elliptical shape which is connected to the second waveguide 30 at a terminal end of the second waveguide 30 in the propagation direction of the light L; and a third waveguide 80 which is connected to the second light circulation portion 10a, at a starting end of the third waveguide 80 in the propagation direction of the light L, at a position different from a position at which the second light circulation portion 10a is connected to the second waveguide 30.

The PD 50 is connected to a terminal end of the third waveguide 80, and the light L emitted from the LED 40 propagates through the first waveguide 20, the light circulation portion 10, the second waveguide 30, the second light circulation portion 10a, the third waveguide 80, and the PD 50, in order. The configuration of the second light circulation portion 10a is similar to the configuration of the light circulation portion 10 in the first embodiment, and the second light circulation portion 10a also has an outer peripheral floating portion 11a. In the second light circulation portion 10a as well, the light L is incident on the third waveguide 80 little by little while circulating multiple times in the outer peripheral floating portion 11a of the second light circulation portion 10a.

According to the optical waveguide 110 of the second embodiment, the light L emitted from the LED 40 circulates multiple times in the outer peripheral floating portion 11 of the light circulation portion 10, and the outer peripheral floating portion 11a of the second light circulation portion 10a before reaching the PD 50. This makes it possible to further increase an optical path length per unit area of the light L propagating from the LED 40 to the PD 50. Therefore, when the optical waveguide 100 is used as a sensor in an optical concentration measuring instrument or the like, it is possible to enhance sensitivity.

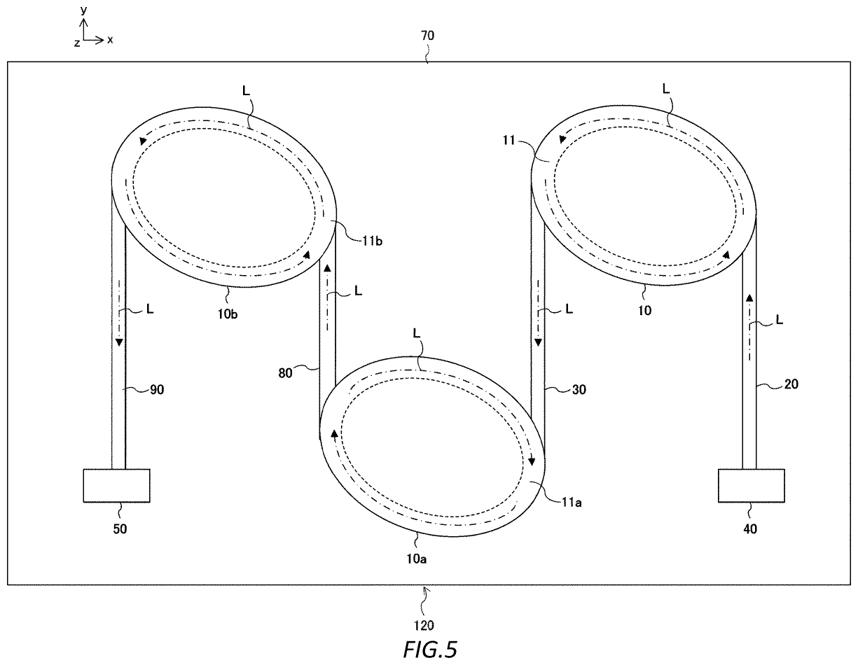

FIG. 5 is a top plan view showing a schematic configuration of an optical waveguide 120 according to a third embodiment. Hereinafter, a component that is the same as that of or in common with the optical waveguide 100 in the first embodiment will be denoted by the same sign and numeral and the description thereof will be omitted. In addition to the configuration of the optical waveguide 110 in the second embodiment, the optical waveguide 120 in the third embodiment has: a third light circulation portion 10b of an elliptical shape which is connected to the third waveguide 80 at a terminal end of the third waveguide 80 in the propagation direction of the light L; and a fourth waveguide 90 which is connected to the third light circulation portion 10b, at a starting end of the fourth waveguide 90 in the propagation direction of the light L, at a position different from a position at which the third light circulation portion 10b is connected to the third waveguide 80.

The PD 50 is connected to a terminal end of the fourth waveguide 90, and the light L emitted from the LED 40 propagates through the first waveguide 20, the light circulation portion 10, the second waveguide 30, the second light circulation portion 10a, the third waveguide 80, the third light circulation portion 10b, the fourth waveguide 90, and the PD 50, in order. The configuration of the third light circulation portion 10b is similar to the configuration of the light circulation portion 10 in the first embodiment, and the third light circulation portion 10b also has an outer peripheral floating portion 11b. In the third light circulation portion 10b as well, the light L is incident on the fourth waveguide 90 little by little while circulating multiple times in the outer peripheral floating portion 11b of the third light circulation portion 10b.

According to the optical waveguide 120 in the third embodiment, the light L emitted from the LED 40 circulates multiple times in the outer peripheral floating portion 11 of the light circulation portion 10, the outer peripheral floating portion 11a of the second light circulation portion 10a, and the outer peripheral floating portion 11b of the third light circulation portion 10b before reaching the PD 50. This makes it possible to further increase an optical path length per unit area of the light L propagating from the LED 40 to the PD 50. Therefore, when the optical waveguide 100 is used as a sensor in an optical concentration measuring instrument or the like, it is possible to enhance sensitivity.

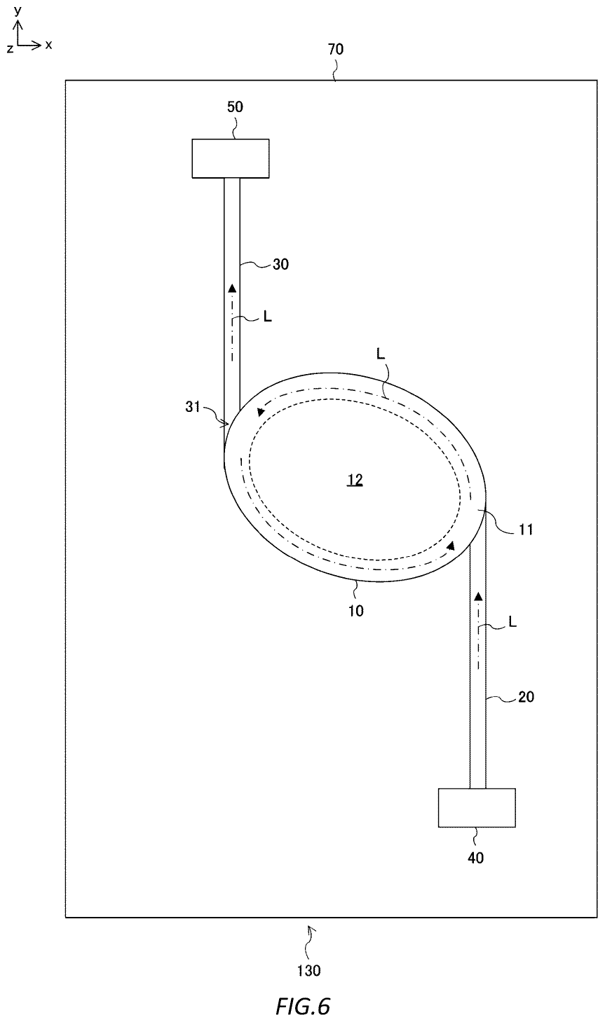

FIG. 6 is a top plan view showing a schematic configuration of an optical waveguide 130 according to a fourth embodiment. Hereinafter, a component that is the same as that of or in common with the optical waveguide 100 in the first embodiment will be denoted by the same sign and numeral and the description thereof will be omitted. The optical waveguide 130 in the fourth embodiment is different from the optical waveguide 100 in the first embodiment, and the second waveguide 30 extends from the light circulation portion 10 in an opposite direction (in the +y direction). Accordingly, the second waveguide 30 is connected to the light circulation portion 10 from a reverse direction of a light circulation direction in the light circulation portion 10.

Similar to the optical waveguide 100 in the first embodiment, the light L emitted from the LED 40 propagates through the first waveguide 20, the light circulation portion 10, the second waveguide 30, and the PD 50, in order. At the starting end 31 which is a connection portion between the light circulation portion 10 and the second waveguide 30, the light L circulating in the light circulation portion 10 propagates toward a left and lower direction in the figure. However, the starting end 31 of the second waveguide 30 is connected toward an upper direction (in the +y direction).

In this way, by the second waveguide 30 being connected to the light circulation portion 10 from a reverse direction of the light circulation direction in the light circulation portion 10, it becomes difficult for the light L to be incident on the second waveguide 30 from the light circulation portion 10, and an average number of times the light L circulates in the light circulation portion 10 increases. This makes it possible to further increase an optical path length per unit area of the light L propagating from the LED 40 to the PD 50. Therefore, when the optical waveguide 100 is used as a sensor in an optical concentration measuring instrument or the like, it is possible to enhance sensitivity.

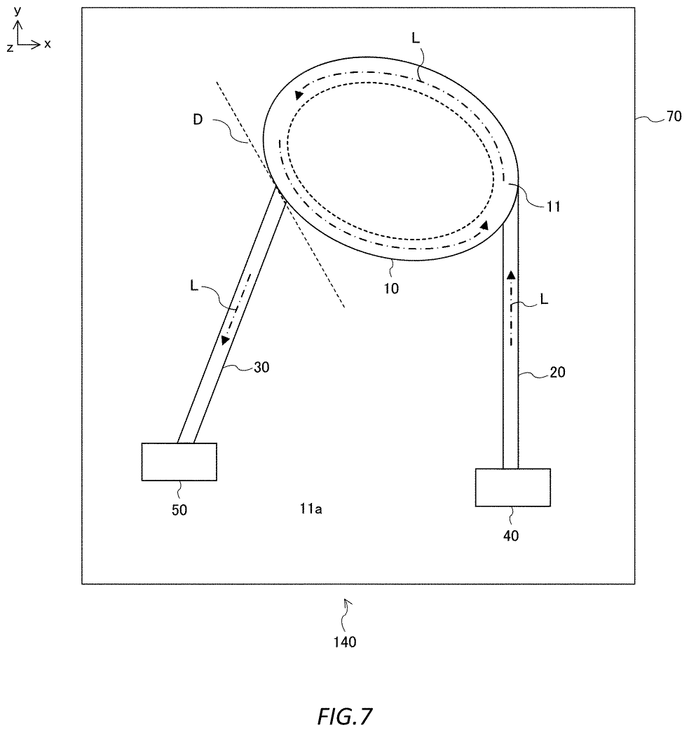

FIG. 7 is a top plan view showing a schematic configuration of an optical waveguide 140 according to a fifth embodiment. Hereinafter, a component that is the same as that of or in common with the optical waveguide 100 in the first embodiment will be denoted by the same sign and numeral and the description thereof will be omitted. The optical waveguide 140 in the fifth embodiment is different from the optical waveguide 100 in the first embodiment, and the second waveguide 30 is connected to the light circulation portion 10 at an angle that is not along a tangent D of an ellipse of the light circulation portion 10.

In this way, by the second waveguide 30 being connected to the light circulation portion 10 at an angle that is not along the tangent D of an ellipse of the light circulation portion 10, it becomes difficult for the light L to be incident on the second waveguide 30 from the light circulation portion 10, and an average number of times the light L circulates in the light circulation portion 10 increases. This makes it possible to further increase an optical path length per unit area of the light L propagating from the LED 40 to the PD 50. Therefore, when the optical waveguide 100 is used as a sensor in an optical concentration measuring instrument or the like, it is possible to enhance sensitivity.

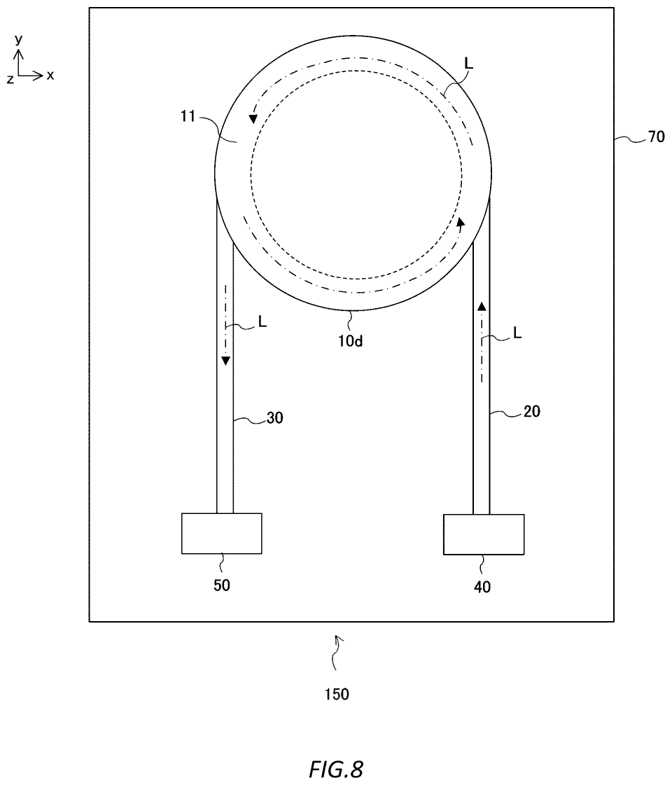

FIG. 8 is a top plan view showing a schematic configuration of an optical waveguide 150 according to a sixth embodiment. Hereinafter, a component that is the same as that of or in common with the optical waveguide 100 in the first embodiment will be denoted by the same sign and numeral and the description thereof will be omitted. The optical waveguide 150 in the sixth embodiment is different from the optical waveguide 100 in the first embodiment, and the light circulation portion 10 has a perfect circular shape. Additionally speaking, the perfect circular shape is said to be an example of an ellipse in which a minor axis and a major axis are equal in length. By setting a perfect circle, it is possible to improve symmetry and cause the light to circulate efficiently. It should be noted that the perfect circle only needs to be a perfect circle in terms of design, and also includes a shape that deviates slightly from a perfect circle due to a manufacturing variation.

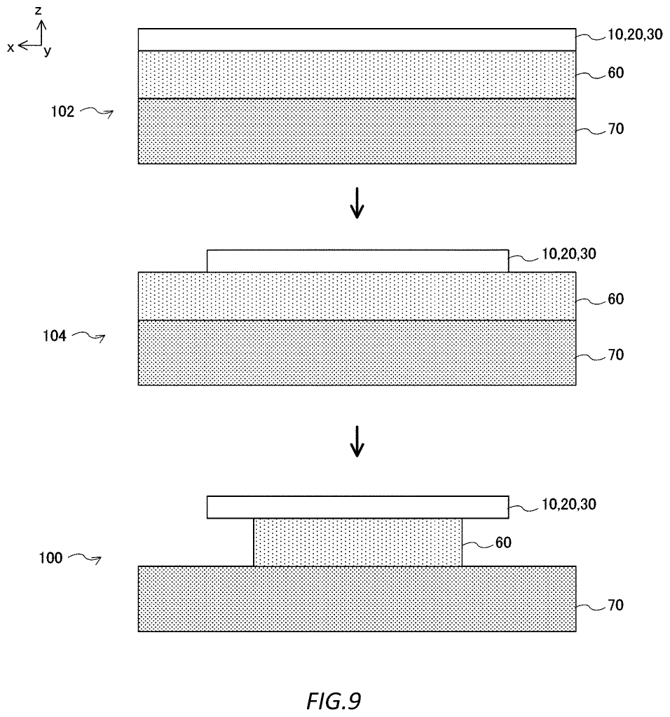

FIG. 9 is a side view for describing a method of manufacturing the optical waveguide 100 according to the first embodiment. First, a stacked body 102 in which a layer for forming the first waveguide 20, the second waveguide 30, and the light circulation portion 10; a layer for forming the cladding layer 60; and a substrate 70 are stacked, is prepared. The stacked body 102 is etched to form the layer for forming the first waveguide 20, the second waveguide 30, and the light circulation portion 10. In this manner, an intermediate body 104 having the first waveguide 20, the second waveguide 30, and the light circulation portion 10, is formed. In the intermediate body 104, the layer constituting the cladding layer 60 is etched to form the cladding layer 60. At this step, portions other than the cladding layer 60 under the light circulation portion 10 are removed by the etching, and the first waveguide 20 and the second waveguide 30 become the floating waveguides floating above the cladding layer 60.

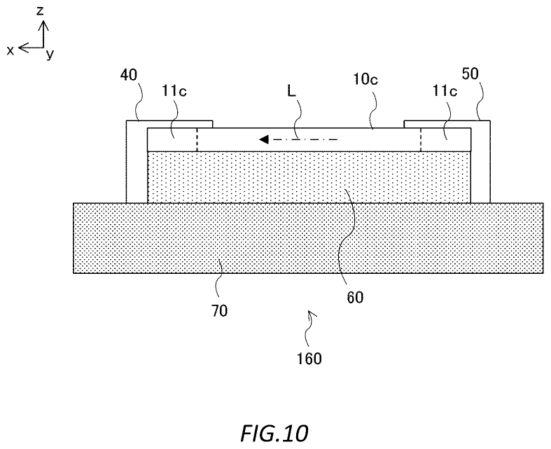

FIG. 10 is a side view showing a schematic configuration of an optical waveguide 160 according to a seventh embodiment. Hereinafter, a component that is the same as that of or in common with the optical waveguide 100 in the first embodiment will be denoted by the same sign and numeral and the description thereof will be omitted. The optical waveguide 160 in the seventh embodiment is different from the optical waveguide 100 in the first embodiment, and a light circulation portion 10c of the optical waveguide 160 does not have an outer peripheral floating portion which is floating from the cladding layer 60. In the light circulation portion 10c, the light L circulates to an outer peripheral portion 11c which is not floating from the cladding layer 60.

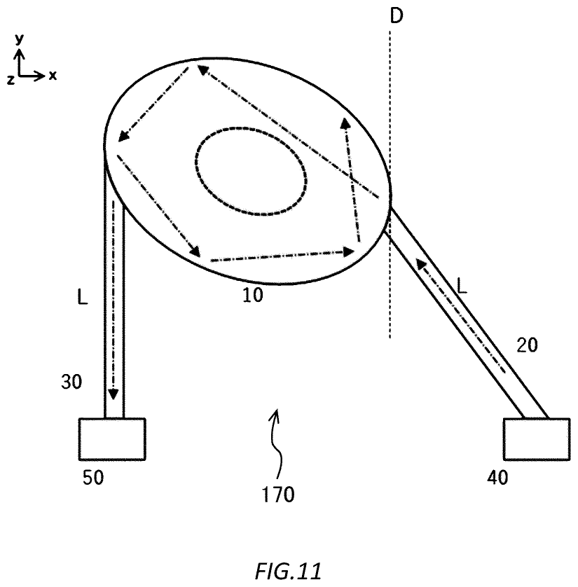

FIG. 11 is a top plan view showing a schematic configuration of an optical waveguide 170 according to an eighth embodiment. Hereinafter, a component that is the same as that of or in common with the optical waveguide 100 in the first embodiment will be denoted by the same sign and numeral and the description thereof will be omitted. The optical waveguide 170 in the eighth embodiment is different from the optical waveguide 100 in the first embodiment, and the first waveguide 20 is connected to the light circulation portion 10 at an angle that is not along the tangent D of an ellipse of the light circulation portion 10.

In this way, by the first waveguide 20 being connected to the light circulation portion 10 at an angle that is not along the tangent D of an ellipse of the light circulation portion 10, it is possible to reduce an angle made between a normal of the ellipse and an angle of incidence when the light L is incident on the outer periphery of the ellipse of the light circulation portion 10. This makes it possible to increase a distance between a reflection point and a reflection point, where an orbit of the light L in the light circulation portion 10 comes into contact with the outer periphery of the light circulation portion 10, and the light L is reflected inside the light circulation portion 10, and thus it is possible to design the reflection point to be away from a specific position on the outer periphery of the ellipse. By setting a positional relationship between the first waveguide 20 and the second waveguide 30 in this way, it becomes difficult for the light L to be incident on the second waveguide 30 from the light circulation portion 10, and an average number of times the light L circulates in the light circulation portion 10 increases. This makes it possible to further increase an optical path length per unit area of the light L propagating from the LED 40 to the PD 50. Therefore, when the optical waveguide 170 is used as a sensor in an optical concentration measuring instrument or the like, it is possible to enhance sensitivity.

While the present invention has been described by way of the embodiments, the technical scope of the present invention is not limited to the scope described in the above-described embodiments. It is apparent to persons skilled in the art that various alterations or improvements can be made to the above-described embodiments. It is also apparent from the description of the claims that the form to which such alterations or improvements are made can be included in the technical scope of the present invention.

It should be noted that the operations, procedures, steps, stages, and the like of each process performed by an apparatus, system, program, and method shown in the claims, the specification, or the drawings can be realized in any order as long as the order is not indicated by “prior to,” “before,” or the like and as long as the output from a previous process is not used in a later process. Even if the operation flow is described by using phrases such as “first” or “next” for the sake of convenience in the claims, specification, and drawings, it does not necessarily mean that the process must be performed in this order.

### EXPLANATION OF REFERENCES

10: light circulation portion; 10a: second light circulation portion; 10b: third light circulation portion; 10c: light circulation portion; 11: outer peripheral floating portion; 11a: outer peripheral floating portion; 11b: outer peripheral floating portion; 11c: outer peripheral portion; 12: center portion; 13: dotted line; 20: first waveguide; 21: starting end; 22: terminal end; 30: second waveguide; 31: starting end; 32: terminal end; 40: LED; 50: PD; 60: cladding layer; 70: substrate; 80: third waveguide; 90: fourth waveguide; 100: optical waveguide; 102: stacked body; 104: intermediate body; 110: optical waveguide; 120: optical waveguide; 130: optical waveguide; 140: optical waveguide; 150: optical waveguide; 160: optical waveguide; 170: optical waveguide; D: tangent of ellipse; L: light; M: minor axis; P: center of gravity.

What is claimed is:

1. An optical waveguide comprising:
a light introduction portion;
a light extraction portion;
a light circulation portion of an elliptical shape;
a first waveguide which is connected to the light introduction portion at a starting end of the first waveguide in a propagation direction of light, and which is connected to the light circulation portion at a terminal end of the first waveguide in a propagation direction of light;
a second waveguide which is connected to the light circulation portion at a starting end of the second waveguide in a propagation direction of light, at a position different from a position at which the light circulation portion is connected to the first waveguide, and which is connected to the light extraction portion at a terminal end of the second waveguide in a propagation direction of light;
a support layer which supports the light circulation portion; and
a substrate which supports the support layer, wherein
in a top plan view, a center of gravity of the light circulation portion is arranged at a position deviated from an extension direction of the first waveguide and the second waveguide, and
light introduced from the light introduction portion propagates through the first waveguide, the light circulation portion, and the second waveguide, in order.

2. The optical waveguide according to claim 1, wherein the first waveguide and the second waveguide are not in contact with the support layer and the substrate.

3. The optical waveguide according to claim 2, wherein the light circulation portion has an outer peripheral floating portion which is not in contact with the support layer and the substrate.

4. The optical waveguide according to claim 3, wherein the first waveguide and the second waveguide are connected to the outer peripheral floating portion of the light circulation portion.

5. The optical waveguide according to claim 3, wherein the first waveguide and the second waveguide are not in contact with the support layer and the substrate.

6. The optical waveguide according to claim 3, wherein a minor radius of the light circulation portion is twice or more of a length of the outer peripheral floating portion in a radial direction.

7. The optical waveguide according to claim 3, wherein widths of the first waveguide and the second waveguide are smaller than or equal to a length of the outer peripheral floating portion in a radial direction.

8. The optical waveguide according to claim 3, wherein a length of the outer peripheral floating portion in a radial direction is twice or less of widths of the first waveguide and the second waveguide.

9. The optical waveguide according to claim 1, wherein the first waveguide or the second waveguide is connected to the light circulation portion at an angle along a tangent of an ellipse of the light circulation portion.

10. The optical waveguide according to claim 1, wherein the first waveguide or the second waveguide is connected to the light circulation portion at an angle that is not along a tangent of an ellipse of the light circulation portion.

11. The optical waveguide according to claim 1, wherein the first waveguide or the second waveguide is connected to the light circulation portion from a reverse direction of a light circulation direction in the light circulation portion.

12. The optical waveguide according to claim 2, wherein refractive indices of materials constituting the first waveguide, the second waveguide, and the light circulation portion are higher than a refractive index of a material constituting the support layer.

13. The optical waveguide according to claim 1, wherein a refractive index of a material constituting the light circulation portion is higher than or equal to refractive indices of materials constituting the first waveguide and the second waveguide.

14. The optical waveguide according to claim 1, wherein the first waveguide and the second waveguide have lengths of 200 μm or less.

15. The optical waveguide according to claim 1, further comprising:
a second light circulation portion of an elliptical shape which is connected to the second waveguide at a terminal end of the second waveguide in a propagation direction of light; and
a third waveguide which is connected to the second light circulation portion at a starting end of the third waveguide in a propagation direction of light, at a position different from a position at which the second light circulation portion is connected to the second waveguide.

16. The optical waveguide according to claim 4, wherein the first waveguide or the second waveguide is connected to the light circulation portion at an angle along a tangent of an ellipse of the light circulation portion.

17. The optical waveguide according to claim 4, wherein the first waveguide or the second waveguide is connected to the light circulation portion at an angle that is not along a tangent of an ellipse of the light circulation portion.

18. The optical waveguide according to claim 4, wherein the first waveguide or the second waveguide is connected to the light circulation portion from a reverse direction of a light circulation direction in the light circulation portion.

19. The optical waveguide according to claim 4, wherein refractive indices of materials constituting the first waveguide, the second waveguide, and the light circulation portion are higher than a refractive index of a material constituting the support layer.

20. The optical waveguide according to claim 4, wherein a refractive index of a material constituting the light circulation portion is higher than or equal to refractive indices of materials constituting the first waveguide and the second waveguide.

21. The optical waveguide according to claim 4, wherein the first waveguide and the second waveguide have lengths of 200 μm or less.

22. The optical waveguide according to claim 4, further comprising:
a second light circulation portion of an elliptical shape which is connected to the second waveguide at a terminal end of the second waveguide in a propagation direction of light; and
a third waveguide which is connected to the second light circulation portion at a starting end of the third waveguide in a propagation direction of light, at a position different from a position at which the second light circulation portion is connected to the second waveguide.

23. An optical concentration measuring instrument comprising the optical waveguide according to claim 1.
